(19) United States
(12) Patent Application Publication
(10) Pub. No.: US 2003/0039347 A1
(43) Pub. Date: Feb. 27, 2003

(54) Sharing telephone directory data by holding telephone directory data in a center on a network

(75) Inventor: Akihiko Katou, Tokyo (JP)

Correspondence Address: FOLEY AND LARDNER, SUITE 500, 3000 K STREET NW, WASHINGTON, DC, 20007, US

(73) Assignee: NEC INFRONTIA CORPORATION

(21) Appl. No.: 10/224,428

(22) Filed: Aug. 21, 2002

(30) Foreign Application Priority Data
Aug. 22, 2001 (JP) 2001-251726

(51) Int. Cl. H04M 3/42

(52) U.S. Cl. 379/218.01

(57) ABSTRACT

A host stores telephone directory data, and a PC and a portable telephone are connected to the host by way of the Internet. The PC includes a keyboard and a network browser, and by entering characters and numbers from the keyboard to operate the network browser, connects to the host by way of the Internet and performs operations on the telephone directory data such as viewing, searching, and registering telephone numbers. The portable telephone is a mobile telephone that includes input buttons and a network browser, and by entering characters and numbers from the input buttons to operate the network browser, connects to the host by way of the Internet and performs operations on the telephone directory data.

### BACKGROUND OF THE INVENTION

1. Field of the Invention

The present invention relates to a method of sharing telephone directory data through the use of the Internet, a telephone set, and a personal computer.

2. Description of the Related Art

An example of a system for sharing telephone directory data of the prior art is disclosed in Japanese Patent Laid-open No. 2000-124985. In this system for sharing telephone directory data, telephone directory data and the telephone number of a communication terminal that is to register this telephone directory data are sent from a personal computer to a center on the Internet. When the telephone directory data and the telephone number are sent from the personal computer, the center originates a call for the telephone number and transmits the telephone directory data to the communication terminal, which is, for example, a portable telephone, PHS (Personal Handyphone System), FAX, or a stationary telephone. The communication terminal registers the telephone directory data that has been transmitted from the center in its own equipment.

However, the above-described system of the prior art has the following problems.

First, the communication terminal itself must have the special capabilities of recognizing that the telephone directory data that have been transmitted from the center on the Internet are telephone directory data, and moreover, of registering the telephone directory data in its own telephone directory.

Second, the system of the prior art cannot handle a case in which there is a plurality of types of telephone directory data, for example, telephone directory data that are differentiated by use. This is because the prior-art system was developed on the assumption that there would be only one type of telephone directory data.

Third, updating of the telephone directory data cannot be carried out from a communication terminal such as a portable telephone, a PHS, or a stationary telephone. This is because the prior-art system was developed on the assumption that registering of telephone directory data would be performed by a personal computer or PDA.

### SUMMARY OF THE INVENTION

It is an object of the present invention to provide a method of sharing telephone directories that does not stipulate that a communication terminal have the special capability of registering in its own telephone directory the telephone directory data that have been transmitted from a center on the Internet.

It is another object of the present invention to provide a method of sharing telephone directories in which telephone directory data can be updated from a communication terminal such as a portable telephone, a PHS, or a stationary telephone that, unlike a personal computer (hereinbelow abbreviated “PC”), does not have a keyboard.

In the method of sharing telephone directories according to the present invention, shared telephone directory data are held by a center on a network, and operations on the telephone directory data such as viewing, searching and registering telephone numbers are performed by way of a network browser such as Internet Explorer.

Accordingly, even a communication terminal that lacks a PC-type of keyboard such as a portable telephone or a PHS is capable of manipulating telephone directory data that are held in a center on the Internet, provided that the communication terminal has loaded a network browser. A communication terminal that lacks a PC-type of keyboard such as a portable telephone, a PHS, or a stationary telephone can update a shared telephone directory.

In addition, if a plurality of types of telephone directory data is registered in a center, a portable telephone, a PHS, or a stationary telephone can, without limitations imposed by memory capacity, easily switch between the telephone directories that are provided according to use.

If a plurality of types of telephone directory data have been registered, switching between telephone directories that are provided according to use can be easily performed from a portable telephone, a PHS, or a stationary telephone.

The above and other objects, features, and advantages of the present invention will become apparent from the following description based on the accompanying drawings, which illustrate examples of preferred embodiments of the present invention.

### BRIEF DESCRIPTION OF THE DRAWINGS

FIG. 1 shows the configuration of the shared telephone directory system according to the first embodiment of the present invention;

FIG. 2 shows a menu screen in the first embodiment;

FIG. 3 shows a telephone directory registration screen in the first embodiment;

FIG. 4 shows a telephone directory screen in the first embodiment;

FIG. 5 is a flow chart showing the operation of the first embodiment;

FIG. 6 shows the configuration of the shared telephone directory system according to the second embodiment of the present invention;

FIG. 7 shows a menu screen in the second embodiment;

FIG. 8 shows a telephone directory registration screen in the second embodiment;

FIG. 9 shows a client telephone directory screen in the second embodiment;

FIG. 10 shows an in-house telephone directory screen in the second embodiment; and

FIG. 11 is a flow chart showing the operations of the second embodiment.

### DETAILED DESCRIPTION OF THE PREFERRED EMBODIMENTS

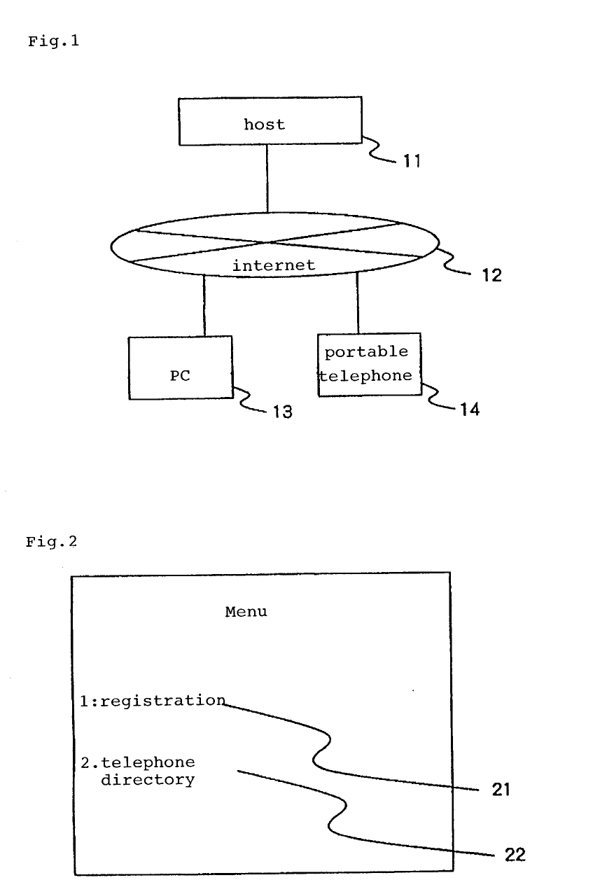

Referring first to FIG. 1, the shared telephone directory system according to a first embodiment of the present invention comprises host 11, Internet 12, PC 13, and portable telephone 14.

Host 11 stores telephone directory data that are constituted by names of companies, names of people, and telephone numbers; connects to Internet 12; and exchanges data with other communication terminal equipment by way of Internet 12. Internet 12 is a network to which host 11, PC 13, and portable telephone 14 are connected. PC 13 includes a keyboard and a network browser, and, by entering characters and numbers from the keyboard to operate the network browser, connects to host 11 by way of Internet 12 and exchanges data. Portable telephone 14 is a mobile telephone that has input buttons and a network browser, and, by entering characters and numbers from the input buttons to operate the network browser, connects to host 11 by way of Internet 12 and exchanges data.

FIGS. 2, 3, and 4 show screen data that are displayed by the network browsers of PC 13 and portable telephone 14 when the telephone directory data of host 11 are used by PC 13 and portable telephone 14. These screen data are constituted by, for example, Hypertext Markup Language (HTML), and allow both input of data from a network browser as well as output of the input data to Internet 12.

Explanation next regards the actual operations when the screen images of FIGS. 2, 3, and 4 are output.

The menu screen of FIG. 2 is a screen image of PC 13 or portable telephone 14. When a connection request is directed to host 11 by way of Internet 12 from PC 13 or portable telephone 14 in FIG. 1, host 11 generates data for realizing display on the network browser that is loaded in PC 13 or portable telephone 14, and transmits this data to PC 13 or portable telephone 14 by way of Internet 12. At this time, the screen image that is shown in FIG. 2 is displayed by the network browser loaded in PC 13 or portable telephone 14. Either Register 21 or Telephone Directory 22 in this screen image of FIG. 2 can be selected at PC 13 and portable telephone 14, and when a selection has been made, data of the selection are transmitted to host 11 by way of Internet 12.

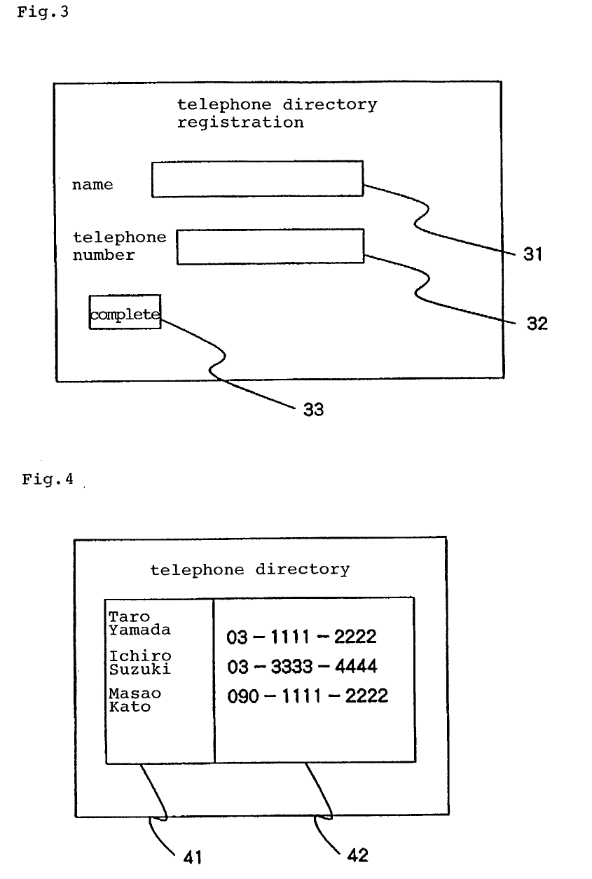

The registration screen of FIG. 3 is a screen image of PC 13. When Register 21 in FIG. 2 has been selected at PC 13, this registration screen is transmitted from host 11 to PC 13 by way of Internet 12 and transmitted to the network browser loaded in PC 13. Name 31 and Telephone Number 32 are items for data input of characters and numbers from PC 13. Complete 33 is a button that is selected from PC 13, and when selected, PC 13 transmits the data that have been entered in Name 31 and Telephone Number 32 to host 11 by way of Internet 12.

The telephone directory screen of FIG. 4 is the screen image of portable telephone 14 in FIG. 1, and when Telephone Directory 22 has been selected at portable telephone 14, the telephone directory data that are held by host 11 are transmitted to portable telephone 14 by way of Internet 12 and transmitted to the network browser loaded in portable telephone 14.

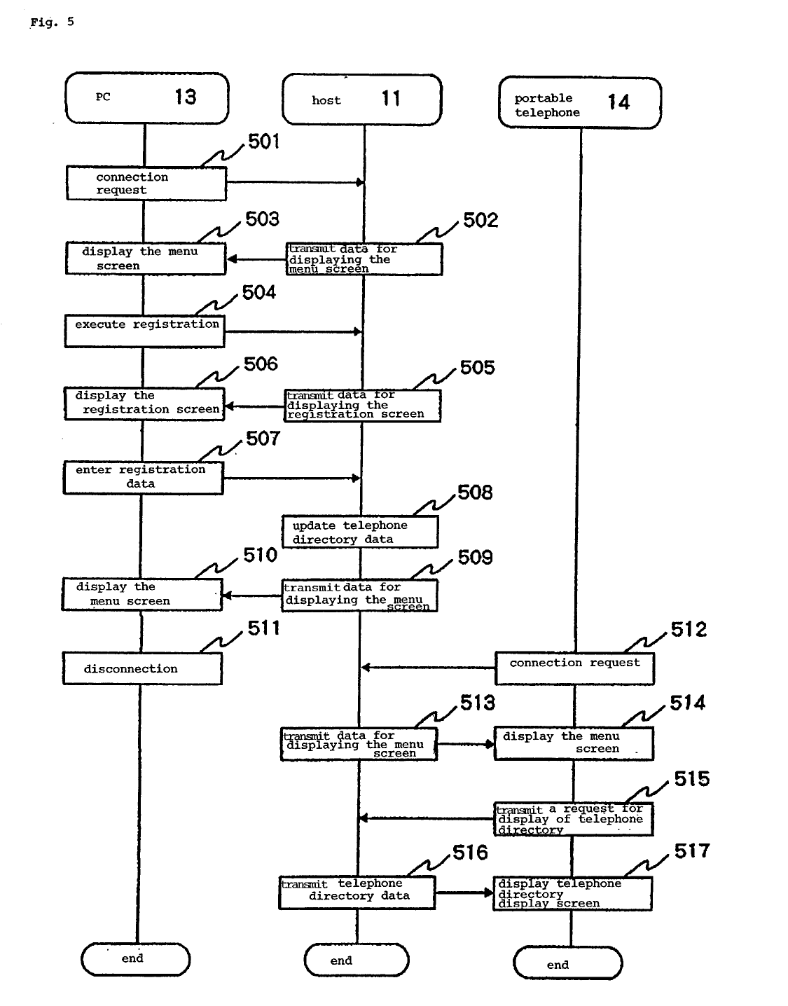

The operations of host 11, Internet 12, PC 13, and portable telephone 14 shown in FIG. 1 are next shown in FIG. 5 is a flow chart showing the procedure for registering telephone directory data from PC 13 to host 11 in the system of FIG. 1, as well as the procedure for acquiring telephone directory data that have been stored in host 11 from portable telephone 14.

First, regarding the procedure for registering a telephone number from PC 13 to telephone directory data that are held by host 11, PC 13 transmits a connection request to host 11 by way of Internet 12 in Step 501. Upon receiving the connection request, host 11 transmits data for displaying the menu screen of FIG. 2 on the browser of PC 13 as menu screen data to PC 13 by way of Internet 12 in Step 502. Upon receiving the menu screen data, PC 13 displays the menu screen in Step 503. At this time, the network browser of PC 13 displays the menu screen of FIG. 2. Register 21 on this menu screen is selected. More specifically, when 1: Register that is displayed on the network browser in PC 13 is applied as input, data indicating that registration is to be executed are transmitted to host 11 by way of Internet 12 in Step 504. Upon receiving the data indicating execution of registration, host 11 transmits data for displaying the registration screen of FIG. 3 on network browser of PC 13 as registration screen data to PC 13 by way of Internet 12 in Step 505. After receiving the registration screen data, PC 13 displays the registration screen in Step 506. At this time, the network browser of PC 13 displays the registration screen that is shown in FIG. 3. The data for Name 31 and Telephone Number 32 that are to be registered in the telephone directory data are entered from this registration screen. In other words, registration data are entered at Name 31 and Telephone Number 32 that are displayed on the network browser on PC 13 in Step 507. When the registration data have been entered, PC 13 transmits telephone directory data that are constituted by a name and telephone number as registration data to host 11 by way of Internet 12. Upon receiving the registration data, host 11 adds the received registration data to the telephone directory data that it holds to update the telephone directory data. After completing the update of telephone directory data, host 11 outputs data for displaying the menu screen of FIG. 2 on the network browser of PC 13 as menu screen data to PC 13 by way of Internet 12 in Step 509. Upon receiving the menu screen data, PC 13 displays the menu screen in Step 510. When the menu screen is displayed, PC 13 recognizes that the update of telephone directory data is complete in Step 511 and disconnects from host 11 by way of Internet 12.

Next, regarding the procedure for acquiring telephone number data held by host 11 from portable telephone 14, portable telephone 14 first transmits a connection request to host 11 by way of Internet 12 in Step 512. Upon receiving the connection request, host 11 transmits data for displaying the menu screen of FIG. 2 on the network browser of portable telephone 14 as menu screen data to portable telephone 14 by way of Internet 12 in Step 513. After receiving the menu screen data, portable telephone 14 displays the menu screen in Step 514. At this time, the network browser of portable telephone 14 displays the menu screen shown in FIG. 2. Telephone directory 22 is then selected from this menu screen. More specifically, when 2: Telephone Directory that is displayed on the network browser is entered at portable telephone 14, data indicating a request for display of telephone directory are transmitted to host 11 by way of Internet 12 in Step 515. Upon receiving the telephone directory display request, host 11 transmits the telephone directory data that it holds in the list screen format of FIG. 4 as telephone directory display screen data for display on the network browser of portable telephone 14 to portable telephone 14 by way of Internet 12 in Step 516. After receiving the telephone directory display screen data, portable telephone 14 displays the telephone directory display screen of FIG. 4 on the loaded network browser in Step 517. In other words, telephone directory data that are held in host 11 can be viewed at portable telephone 14.

Thus, in the present embodiment, telephone directory data are held in host 11, which is a sever on Internet 12, and, by allowing the manipulation of this telephone directory data by a network browser, this telephone directory data can be shared by a portable telephone or personal computer in which a network browser is loaded.

Further, since the capability to update telephone directory data from a personal computer is also provided in the present embodiment, a PC can be used to update telephone directory data in place of a portable telephone, on which the number of buttons is limited and operation for character input is therefore inconvenient. In the present embodiment, if a portable telephone has the capability to confirm and dial a telephone number that is included in displayed telephone directory data, this capability can be used to dial from telephone directory data.

Although the Internet is used as the network in the present embodiment, a private network such as an intranet may also be used.

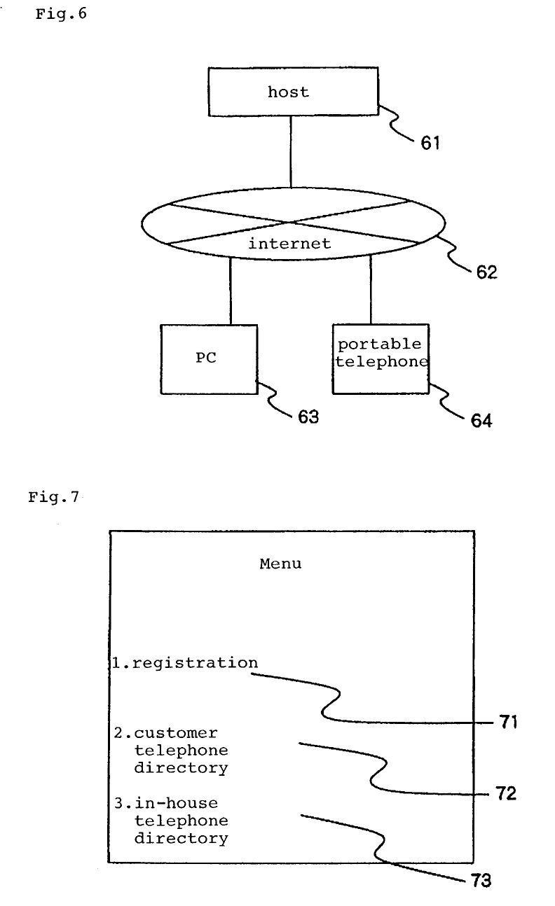

Another embodiment of the present invention is equivalent in basic configuration to the above-described embodiment but has additional expedients regarding the telephone directory data that are held by the host. The configuration of this embodiment is shown in FIG. 6. In this figure, host 61 stores two types of telephone directory data that are distinguished according to use: customer telephone directory data and in-house telephone directory data, each type of telephone directory data being constituted by affiliations, names, and telephone numbers; connects to Internet 62; and exchanges data with other communication terminal equipment by way of Internet 62. Internet 62 is a network that connects host 61, PC 63, and portable telephone 64. PC 63 includes a keyboard and a network browser, and, through the input of characters and numbers from the keyboard to operate the network browser, connects to host 61 by way of Internet 62 and exchanges data. Portable telephone 64 is a mobile telephone that has input buttons and a network browser, and, through input of characters and numbers from the input buttons to operate the network browser, connects to host 61 by way of Internet 62 and exchanges data.

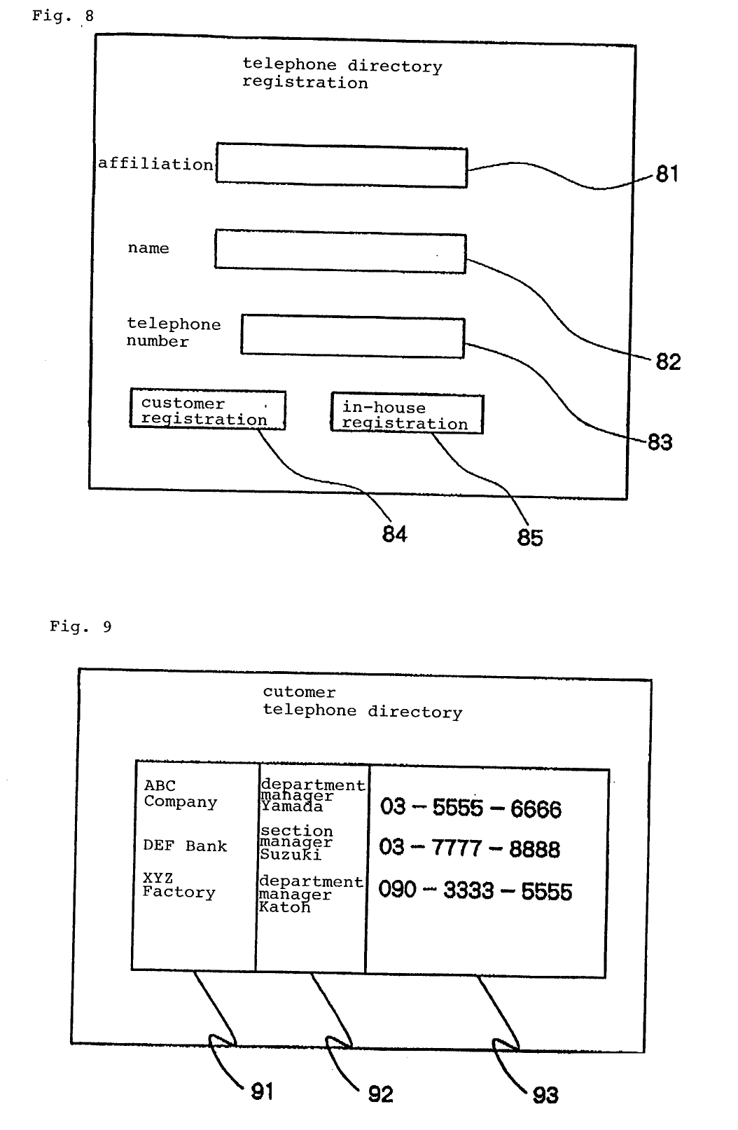

FIGS. 7, 8, 9, and 10 show screen data that are displayed by the network browser of PC 63 and portable telephone 64 when the telephone directory data of host 61 in FIG. 6 are to be used at PC 63 and portable telephone 64. These screen data are constituted by, for example, HTML, and enable both input of data from a network browser as well as output of data input to Internet 62.

Explanation next regards the actual operations when outputting the screen images of FIGS. 7, 8, 9, and 10.

The menu screen of FIG. 7 is a screen image of PC 63 or portable telephone 64 in FIG. 6. When a connection request is issued to host 61 by way of Internet 62 from PC 63 or portable telephone 64 in FIG. 6, host 61 generates data for implementing display to the network browser that is loaded in PC 63 or portable telephone 64, and transmits this data to PC 63 or portable telephone 64 by way of Internet 62. At this time, PC 63 or portable telephone 64 displays the screen image shown in FIG. 7 by means of the loaded network browser. PC 63 and portable telephone 64 can select any one of Register 71, Customer Telephone Directory 72, and In-house Telephone Directory 73 on the screen image of FIG. 7, and when a selection is made, the selected data are transmitted to host 61 by way of Internet 62.

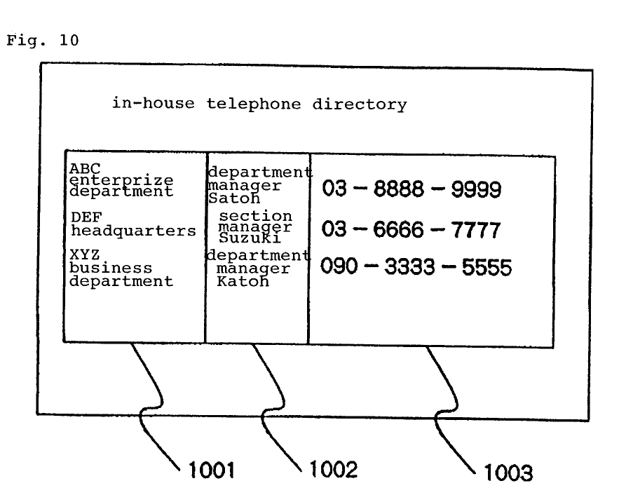

The registration screen of FIG. 8 is the screen image of PC 63 in FIG. 6 and is transmitted from host 11 to PC 63 by way of Internet 62 when Register 71 in FIG. 7 has been selected at PC 63 and transmitted to the network browser that is loaded in PC 63. Affiliation 81, Name 82, and Telephone Number 83 are items for which data entry of characters and numbers must be performed from PC 63. Customer registration button 84 and in-house registration button 85 are buttons that are selected from PC 63, and when a selection has been made, data identifying the button that has been selected along with the data that have been entered in Affiliation 81, Name 82, and Telephone Number 83 at PC 63 are transmitted to host 61 by way of Internet 62.

The customer telephone directory screen of FIG. 9 is a screen image of portable telephone 64 in FIG. 6. This screen is the customer telephone directory data of the telephone directory data held by host 61 that is transmitted to portable telephone 64 by way of Internet 62 and transmitted to the network browser that is loaded in portable telephone 64 when portable telephone 64 has selected Customer Telephone Directory 72 in FIG. 7. This screen essentially displays a list of Customer Affiliations 91, Names 92, and Telephone Numbers 93.

The in-house telephone directory screen of FIG. 10 is a screen image of portable telephone 64 in FIG. 6, and when In-house Telephone Directory 73 in FIG. 7 has been selected at portable telephone 64, this screen is the in-house telephone directory data of the telephone directory data held by host 61 that is transmitted to portable telephone 64 by way of Internet 62, and transmitted to the network browser that is loaded in portable telephone 64. Essentially, a list is displayed of Affiliations 1001, Names 1002, and Telephone Numbers 1003.

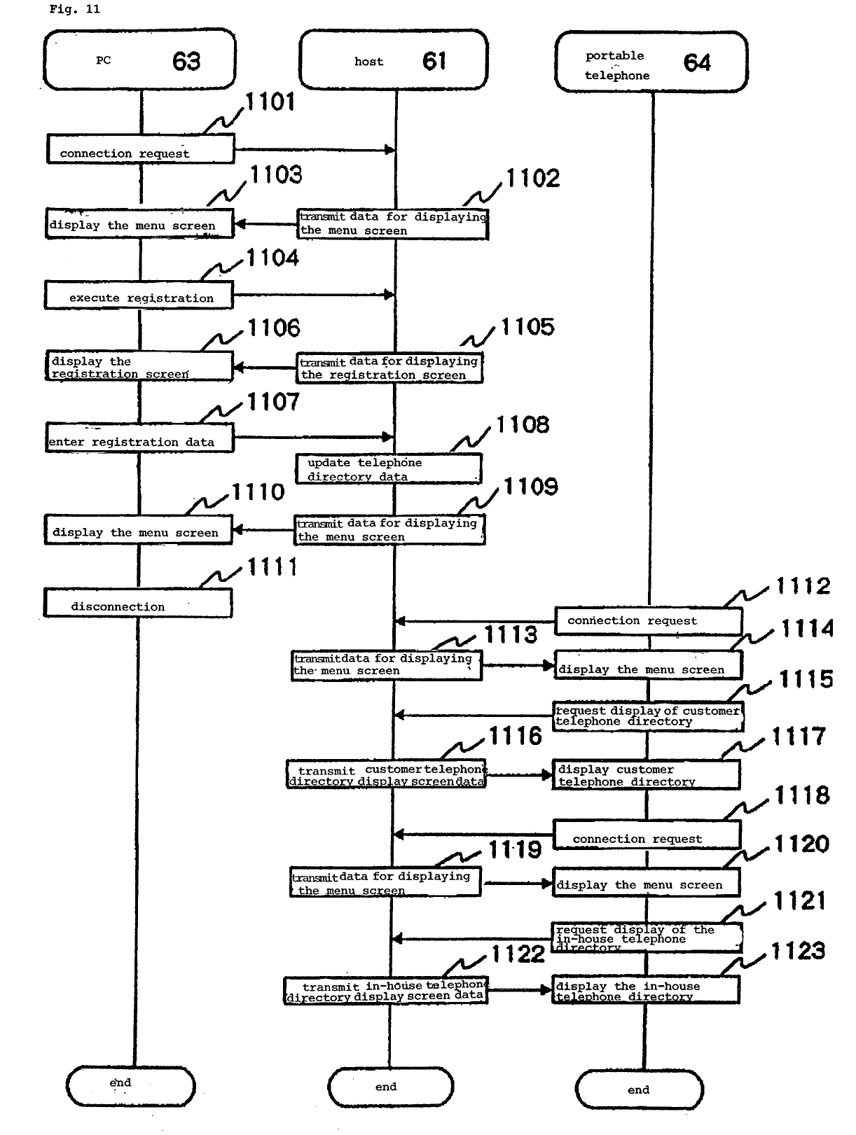

The operations of host 61, Internet 62, PC 63 and portable telephone 64 of FIG. 6 are shown in FIG. 11. FIG. 11 is a flow chart showing the procedure for registering telephone directory data from PC 63 to host 61 in the system of FIG. 6 as well as the procedure for acquiring telephone directory data that are stored in host 61 from portable telephone 64.

Explanation first regards the procedures for registering a telephone number from PC 63 to the telephone directory data that are held by host 61. PC 63 first transmits a connection request to host 61 by way of Internet 62 in Step 1101. Upon receiving the connection request, host 61 transmits data for displaying the menu screen of FIG. 7 on the network browser of PC 63 as menu screen data to PC 63 by way of Internet 62 in Step 1102. After receiving the menu screen data, PC 63 displays the menu screen in Step 1103. At this time, the network browser of PC 63 displays the menu screen shown in FIG. 7.

The user selects Register 71 in this menu screen. More specifically, upon selection of 1: Register that is displayed on the network browser in PC 63, data indicating that registration is to be executed are transmitted to host 61 by way of Internet 62 in Step 1104. Upon receiving the data indicating execution of registration, host 61 transmits data for displaying the registration screen of FIG. 8 to the network browser of PC 63 as registration screen data to PC 63 by way of Internet 62 in Step 1105. Upon receiving the registration screen data, PC 63 displays the registration screen in Step 1106. At this time, the network browser of PC 63 displays the registration screen shown in FIG. 8. From this registration screen, the user performs input of registration data in Step 1107 by entering the data of Affiliation 81, Name 82, and Telephone Number 83 that are to be registered in the telephone directory data. After completing input of the registration data in PC 63, the button indicating the type of the telephone directory that is to be registered is applied as input, i.e., Customer Registration button 84 is pushed when registering in the customer telephone directory and In-house Registration button 85 is pushed when registering in the in-house telephone directory.

When PC 63 enters Customer Registration button 84 or In-house Registration button 84, the registration data that are constituted by Affiliation 81, Name 82, Telephone Number 83 and the identification data indicating the type of telephone directory data that are to be registered are transmitted to host 61 by way of Internet 62 in Step 1107. After receiving the registration data, host 61 identifies the type of telephone directory data that are to be registered by means of the identification data within the registration data and adds the registration data to the relevant telephone directory data to update the telephone directory data in Step 1108. Upon completing the updating of the telephone directory data, host 61 transmits data for displaying the menu screen of FIG. 7 to the network browser of PC 63 as menu screen data to PC 63 by way of Internet 62 in Step 1109. PC 63, upon receiving the menu screen data, displays the menu screen in Step 1110. Upon displaying the menu screen, PC 63 recognizes that the update of the telephone directory data has been completed and disconnects from host 61 by way of Internet 62 in Step 1111.

Next, regarding the procedure for acquiring telephone directory data held by host 61 from portable telephone 64, host 61 holds both customer telephone directory data and in-house telephone directory data, but an example is given here in which the customer telephone directory data are used. Portable telephone 64 first transmits a connection request to host 61 by way of Internet 62 in Step 1112. Upon receiving the connection request, host 61 transmits data for displaying the menu screen of FIG. 7 on the network browser of portable telephone 64 as menu screen data to portable telephone 64 by way of Internet 62 in Step 1113. After receiving the menu screen data, portable telephone 64 displays the menu screen in Step 1114. At this time, the network browser of portable telephone 64 displays the menu screen shown in FIG. 7.

In this menu screen, Customer Telephone Directory 72 is selected. More specifically, when 2: Customer Telephone Directory that is displayed on network browser in portable telephone 64 is applied as input, data indicating a request for the customer telephone directory is transmitted to host 61 by way of Internet 62 in Step 1115. In Step 1116, upon receiving the request for customer telephone directory, host 61 transmits the telephone directory data that it holds to portable telephone 64 by way of Internet 62 as customer telephone directory display screen data for display on the network browser of portable telephone 64 in the format of the list screen of FIG. 9. Upon receiving the telephone directory display screen data, portable telephone 64 displays the customer telephone directory display screen of FIG. 9 on the loaded network browser. In other words, the customer telephone directory data that is held in host 61 can be viewed on portable telephone 64.

Although host 61 holds both customer telephone directory data and in-house telephone directory data, an example is shown for a case in which the in-house telephone directory data are used. In Step 1118, portable telephone 64 transmits a connection request to host 61 by way of Internet 62. Upon receiving the connection request, host 61 transmits data for displaying the menu screen of FIG. 7 on the network browser of portable telephone 64 as menu screen data to portable telephone 64 by way of Internet 62 in Step 1119. After receiving the menu screen data, portable telephone 64 displays the menu screen in Step 1120. At this time, the network browser of portable telephone 64 displays the menu screen shown in FIG. 7. The user selects In-house Telephone Directory 73 in this menu screen. More specifically, when 3: In-house Telephone Directory that is displayed in the network browser in portable telephone 64 is selected, data indicating a request of the in-house telephone directory is transmitted to host 61 by way of Internet 62 in Step 1121. Upon receiving the request for in-house telephone directory, host 61 transmits the telephone directory data that it holds to portable telephone 64 by way of Internet 62 as in-house telephone directory display screen data for displaying in the format of the list screen of FIG. 10 on the network browser of portable telephone 64 in Step 1122. After having received the in-house telephone directory display screen data, portable telephone 64 displays the in-house telephone directory display screen of FIG. 10 on the loaded network browser in Step 1123. In other words, the in-house telephone directory data that are held in host 61 can be viewed on portable telephone 64.

According to this embodiment, a plurality of types of telephone directory data items are held in a server on the Internet, and by allowing manipulation of these telephone directory data through the operation of a network browser, a plurality of types of telephone directory data items can be shared by a portable telephone or a personal computer in which a network browser is loaded.

Thus, in this embodiment, a plurality of types of telephone directories are held at a host, and a telephone directory that suits a particular purpose can be used from a portable telephone.

Although the Internet is used as the network in the present embodiment, a private network such as an intranet may be used as the network.

Finally, the processing of PC 13 and 63, host 11 and 61, and portable telephone 14 and 64 that is shown in FIGS. 5 and 11 can also be stored on a storage medium such as a floppy disk, a CD-ROM, a magneto-optical disk, or a hard disk and executed by, for example, a personal computer.

While preferred embodiments of the present invention have been described using specific terms, such description is for illustrative purposes only, and it is to be understood that changes and variations may be made without departing from the spirit or scope of the following claims.

What is claimed is:

1. A method of sharing a telephone directory, wherein telephone directory data are held by a center on a network, and operations on said telephone directory data are performed by way of a network browser of a communication terminal that has loaded the network browser.

2. A method according to claim 1, wherein said center holds a plurality of types of telephone directory data.

3. A method of registering telephone directory data in telephone directory data that are held in a center on a network from a communication terminal in which a network browser has been loaded, said method comprising steps of:
transmitting a connection request to said center by way of said network;
displaying a menu screen based on menu screen data that have been transmitted by said center by way of said network;
selecting “Register” that is displayed on said menu screen to transmit data indicating that registration is to be executed to said center by way of said network;
displaying a registration screen based on registration screen data that have been transmitted by said center by way of said network;
transmitting, as registration data to said center by way of said network, telephone directory data that are constituted by a name and telephone number that have been entered from said registration screen;
after said center has added said registration data to said telephone directory data to complete updating said telephone directory data, displaying a menu screen based on menu screen data that have been transmitted by said center by way of said network; and
disconnecting the connection with said center by way of said network.

4. A method according to claim 3, wherein identification data for identifying a telephone directory in which a name and telephone number are to be registered are transmitted to said center together with said registration data.

5. A method of acquiring telephone directory data from telephone directory data that are held by a center on a network from a communication terminal in which a network browser has been loaded, said method comprising steps of:
transmitting a connection request to said center by way of said network;
displaying a menu screen based on menu screen data that have been transmitted by said center by way of said network;
selecting “Telephone Directory” that is displayed on said menu screen to transmit to said center by way of said network a request to display a telephone directory; and
displaying a telephone directory display screen based on telephone directory display screen data for displaying telephone directory data that are held in said center and have been transmitted by said center by way of said network.

6. A method according to claim 5, wherein there are a plurality of “Telephone Directories” displayed on said menu screen, each telephone directory being provided according to the type of telephone directory data.

7. A computer program for enabling a computer to register telephone directory data into telephone directory data that are held by a center on a network from a communication terminal in which a network browser has been loaded; said computer program comprising instructions for:
transmitting a connection request to said center by way of said network;
displaying a menu screen based on menu screen data that have been transmitted by said center by way of said network;
selecting “Register” that is displayed on said menu screen to transmit data indicating that registration is to be executed to said center by way of said network;
displaying a registration screen based on registration screen data that have been transmitted by said center by way of said network;
transmitting, as registration data to said center by way of said network, telephone directory data that are constituted by a name and telephone number that have been entered from said registration screen;
after said center has added said registration data to said telephone directory data to complete updating of said telephone directory data, displaying a menu screen based on menu screen data that have been transmitted from said center by way of said network; and
disconnecting the connection with said center by way of said network.

8. A computer program according to claim 7, further comprising an instruction for transmitting to said center identification data for identifying a telephone directory in which a name and telephone number are to be registered together with said registration data.

9. A computer program for enabling a computer to acquire telephone directory data from telephone directory data that are held by a center on a network from a communication terminal that has loaded a network browser, said computer program comprising instructions for:
transmitting a connection request to said center by way of said network;
displaying a menu screen based on menu screen data that have been transmitted by said center by way of said network;
selecting “Telephone Directory” that is displayed in said menu screen to transmit to said center by way of said network a request to display a telephone directory; and
displaying a telephone directory display screen based on telephone directory display screen data for displaying telephone directory data that are held in said center and have been transmitted by said center by way of said network.

10. A computer program according to claim 9, wherein there exists a plurality of “Telephone Directories” that are displayed on said menu screen, each telephone directory being provided according to a type of telephone directory data.
